(19) United States
(12) Patent Application Publication
(10) Pub. No.: US 2007/0186119 A1
(43) Pub. Date: Aug. 9, 2007

(54) POWER SYSTEM CAPABLE OF REDUCING INTERFERENCE BETWEEN VOLTAGE OUTPUT PORTS ON A DAUGHTER BOARD

(76) Inventors: Chih-Chiang Yu, Taipei Hsien (TW); Chin-Lung Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/383,960

(22) Filed: May 18, 2006

(30) Foreign Application Priority Data
Feb. 6, 2006 (TW) 095103904

(51) Int. Cl. G06F 1/00

(52) U.S. Cl. 713/300

(57) ABSTRACT

A power system includes a motherboard, a daughter board, and a cable. The cable connects the motherboard and the daughter board. The daughter board includes voltage output ports for outputting the same voltage. Each power transmission path on the daughter board is isolated. The cable includes power lines respectively connected to the isolated power transmission paths on the daughter board. Therefore, this can reduce interference between the voltage output ports of the daughter board.

### BACKGROUND OF THE INVENTION

1. Field of the Invention

The present invention relates to a power system, and more particularly, to a power system capable of reducing interference between voltage output ports on a daughter board.

2. Description of the Prior Art

Generally, a housing of a computer has input/output ports, such as a universal serial bus (USB) port, to connect other electronic devices externally. These input/output ports are usually integrated in a daughter board, which communicates with a motherboard of the computer via cables.

Take USB ports for example. There are usually two USB ports on the housing of the computer. Since these two USB ports output the same voltage to the external electronic devices, the power pins of these two USB ports are usually connected to the same power plane or to the same power trace. When a USB electronic device is inserted into one of these two USB ports and the USB electronic device is operating, if another USB electronic device is suddenly inserted into the other USB port, the voltage potential of the operating USB electronic device will droop. According to a specification for USB 2.0, the drooping range should be within 330 mV so that the operating USB electronic device can still operate properly.

In addition, when two USB electronic devices are operating at the same time, since loadings of each USB electronic device are different, the USB electronic devices might interfere with each other.

Please refer to FIG. 1 and 2, which are diagrams of power systems 1, 2 based on the prior art. The power system 1 comprises a motherboard 10, a daughter board 30 and a cable 20. The motherboard 10 comprises a regulator capacitor 12 coupled to a voltage output port 14. The daughter board 30 comprises two voltage output ports 32, 34, a voltage input port 31, and a power plane 36. The voltage output ports 32, 34, and voltage input port 31 are all coupled to the power plane 36. The cable 20 only provides a power line 22 to connect the voltage output port 14 of the motherboard 10 and the voltage input port 31 of the daughter board 30.

The daughter board 30 of the power system 2 further comprises a voltage input port 33, and thereby the cable 20 of FIG. 2 provides two power lines 22, 24 to respectively connect the voltage input ports 31, 33 of the daughter board 30 to the voltage output port 14 of the mother board 10. The voltage output ports 32, 34, and voltage input ports 31, 33 are all coupled to the power plane 36.

As shown in FIG. 1 and FIG. 2, suppose that a USB electronic device is connected to the voltage output port 32 of the daughter board 30 and is operating. If another USB electronic device is suddenly inserted into the USB port with the voltage output port 34, the drooping phenomenon can occur, as shown by arrows in FIG. 1 and 2, to influence the voltage potential of the voltage output port 32. Although the mother board 10 comprises the regulator capacitor 12, an inductance effect on the power lines 22, 24 causes the regulator capacitor 12 of the mother board 10 not to immediately compensate the voltage output port 32 for the drooping voltage when suddenly inserting the external electronic device.

The solution in the prior art is to add regulator capacitors on the daughter board 30. Please refer to FIG. 3 and 4, which are diagrams of a power system 3, 4 based on the prior art. The power system 3 further comprises a regulator capacitor 35 of about 22 μF between the voltage output ports 32, 34 and the voltage input ports 31, 33. The power system 4 further comprises regulator capacitors 37, 39 of about 220 μF at the voltage output ports 32, 34, respectively.

Please refer to FIG. 5, which is a table of drooping voltages of FIG. 2 to FIG. 4. The drooping voltage (drooping range) of FIG. 2 does not conform to USB 2.0. Although the power system 3 of FIG. 3 comprises the regulator capacitor 35, it does not conform to USB 2.0, either. In FIG. 4, the regulator capacitors 37, 39 are positioned at the voltage output ports 32, 34 to make it conform to USB 2.0. However, the larger regulator capacitor requires more material and cost.

### SUMMARY OF THE INVENTION

The claimed invention provides a power system capable of reducing inference between voltage output ports on a daughter board. The power system comprises a daughter board, a motherboard, and a plurality of power lines. The daughter board comprises a plurality of voltage output ports for outputting a same voltage and a plurality of voltage input ports. Each voltage input port is coupled to a corresponding voltage output port to form isolated power paths. The motherboard comprises a voltage output port for providing electric power to the voltage input ports of the daughter board and a plurality of power lines. Each power line is coupled between a corresponding voltage input port of the daughter board and the voltage output port of the motherboard.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 4 are diagrams of power systems based on the prior art.

FIG. 5 is a table of drooping voltages of FIG. 2 to FIG. 4.

FIG. 6 and FIG. 7 are diagrams of power systems based on the present invention.

FIG. 8 is a table of drooping voltages of FIG. 6 to FIG. 7.

FIG. 9 is an embodiment of an electronic device based on the present invention.

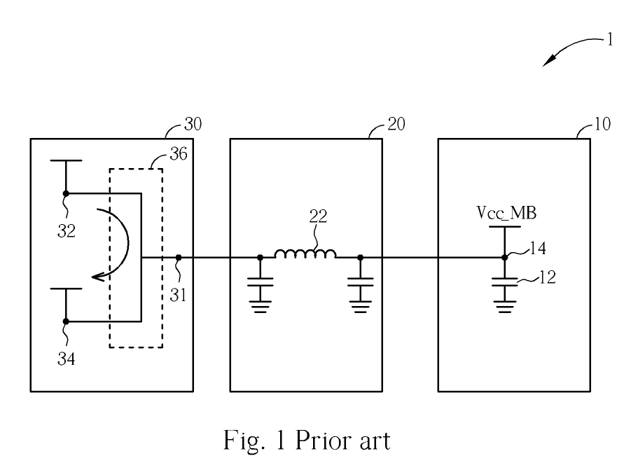

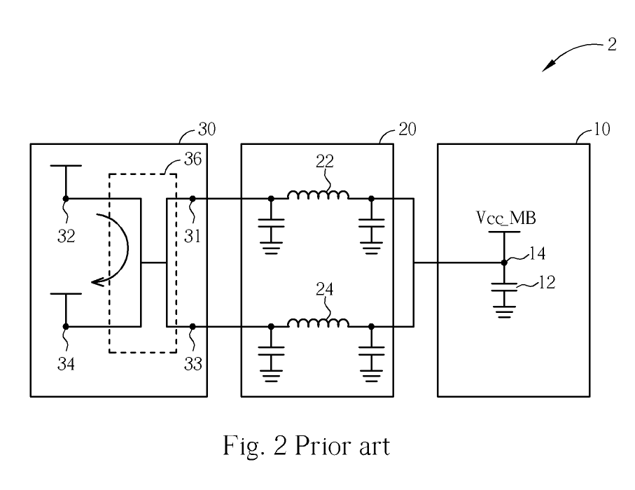

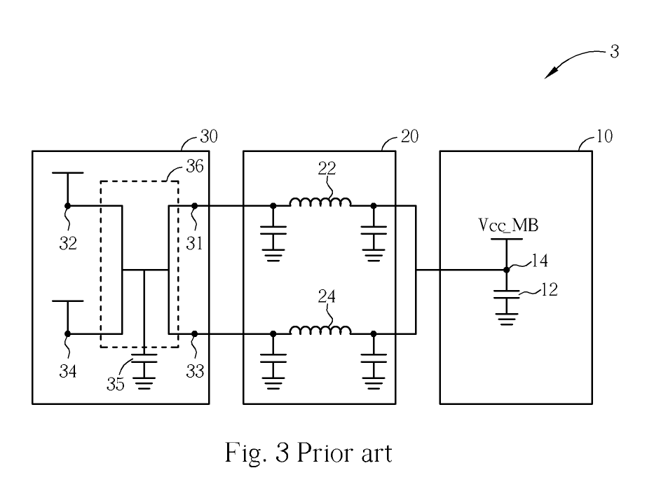

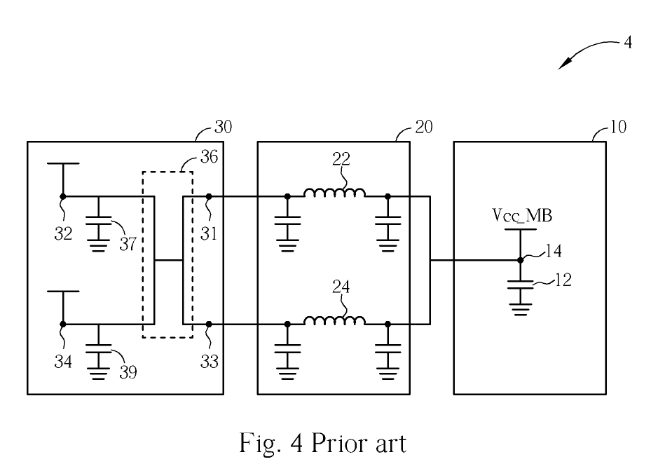

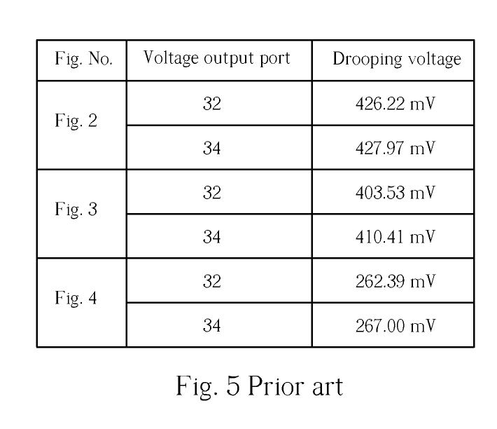

### DETAILED DESCRIPTION

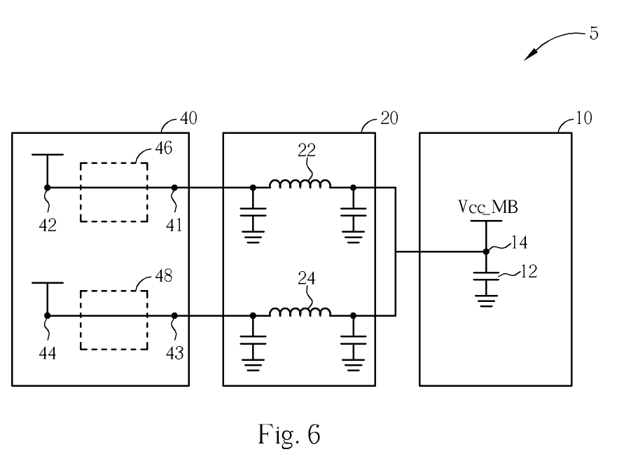

Please refer to FIG. 6, which is a diagram of a power system 5 of the present invention. Different from the prior art, a daughter board 40 of the power system 5 comprises two voltage output ports 42, 44, two voltage input ports 41, 43, and two power planes 46, 48. The voltage output port 42 and the voltage input port 41 are both electrically connected to the power plane 46, while the voltage output port 44 and the voltage input port 43 are both electrically connected to the power plane 48. Additionally, the power lines 22, 24 are electrically connected to the voltage input ports 41, 43, respectively.

If a USB electronic device were inserted into the USB port having the voltage output port 42, the drooping phenomenon due to the inserting would not directly influence the voltage potential of the voltage output port 44. The reason is that the drooping phenomenon is sequentially transmitted through the power plane 46, the power line 22, the regulator capacitor 12, the power line 24, and the power plane 48, and finally to the voltage output port 44. This long path is equivalent to connecting two inductances serially (the equivalent inductances of the power lines 22, 24) and connecting a regulator capacitor (the regulator capacitor 12) in parallel, so that the drooping phenomenon is reduced.

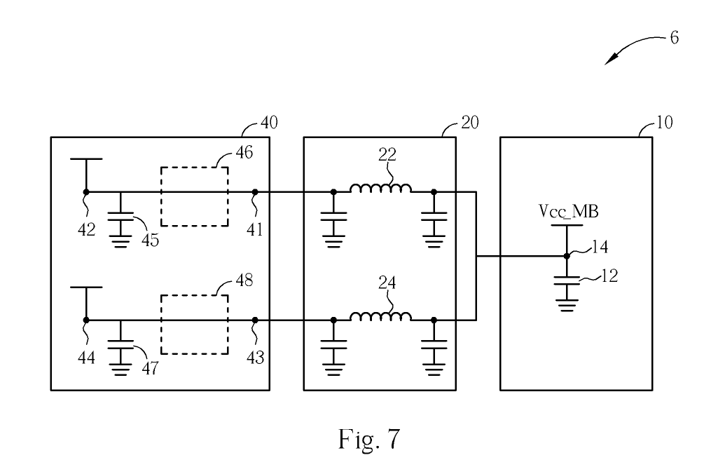

For better performance, regulator capacitors can be placed on the daughter board 40. Please refer to FIG. 7, which is a diagram of a power system 6 based on the present invention. The power system 6 comprises regulator capacitors 45, 47 (about 220 μF) at the voltage output ports 42, 44, respectively.

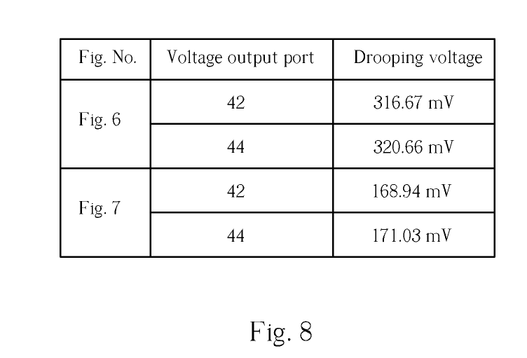

Please refer to FIG. 8, which is a table of drooping voltages of FIG. 6 and FIG. 7. In FIG. 6, the power transmission paths are separated (isolated) on the daughter board 40 so as to reduce the drooping voltage and make it conform to USB 2.0. In FIG. 7, the regulator capacitors 45, 47 can make the drooping voltage much smaller than 330 mV for better performance.

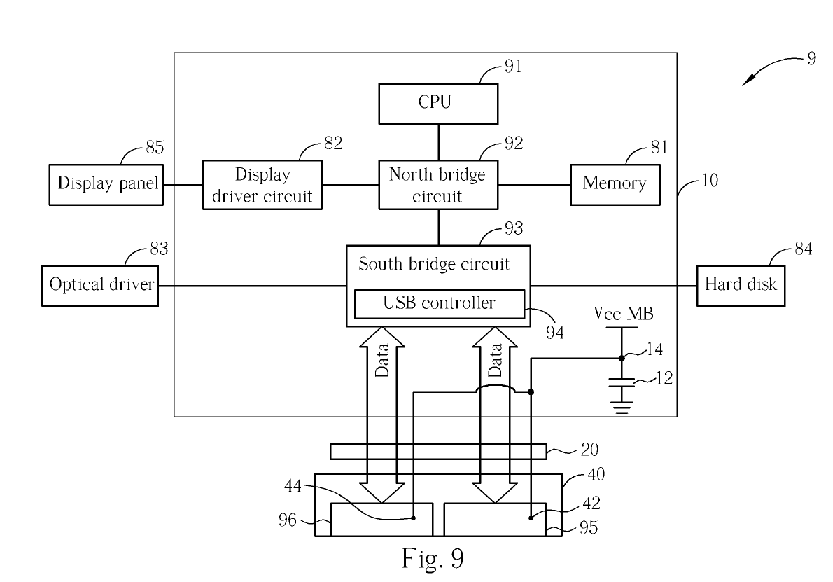

Next, the power system of the present invention is implemented in an electronic device. Please refer to FIG. 9, which is a diagram of an electronic device 9 based on the present invention. The electronic device 9 comprises a central processing unit (CPU) 91, a north bridge circuit 92, a south bridge circuit 93, a plurality of connecting ports 95, 96 for outputting the same voltage, and a display panel 85. The CPU 91, the north bridge circuit 92 and the south bridge circuit 93 are positioned on the motherboard 10. The connecting ports 95, 96 are positioned on the daughter board 40, where the connecting ports 95, 96 comprise the voltage output ports 42, 44, respectively. Please refer to FIG. 6 or 7 for the details of the cable 20 and the daughter board 40 in FIG. 9. The CPU 91 controls the entire operation of the electronic device 9; the north bridge circuit 92 controls the communication between high-speed devices (such as a display driver circuit 82 and a memory 8) and the CPU 91; the display panel shows images according to data processed by the display driver circuit 82; and the south bridge circuit 93 controls the communication between low-speed devices (such as an optical driver 83 and a hard disk 84) and the north bridge circuit 92. A user can insert peripheral devices into the electronic device 9 via the connecting ports 95, 96, such as USB ports or IEEE 1394 ports. Take USB ports for example. The south bridge circuit 93 comprises a USB controller 94 to control data transmission.

After the electronic device is powered on, a power-on-self-test (POST) is executed, and then an operating system (OS) is loaded. When the CPU executes the OS, the OS detects all hardware installed in the electronic device 9 and loads device drivers correspondingly to control all hardware and to provide power to external electronic devices. How the external electronic devices obtains power has been described in the power system 5, 6 of the present invention, and further description is omitted herein. The electronic device 9 of the present invention can be a notebook computer, a personal computer, or other electronic devices having a plurality of connecting ports for outputting the same voltage.

In addition, if two USB devices are inserted into the connecting ports 95, 96 and are operating at the same time, since power paths on the daughter board 40 are isolated, interference between voltage potential of the two USB devices is prevented.

The present invention isolates power paths on the daughter board and utilizes different power lines to respectively connect the power paths on the daughter board. The drooping phenomenon can be reduced by the equivalent inductance on the power lines and the regulator capacitor of the motherboard. Moreover, the present invention can reduce inference when two USB devices are operating. The power system of the present invention can be implemented in specifications for USB 2.0 or IEEE 1394, and even other daughter boards having many voltage output ports for outputting the same voltage. Lastly, the power planes can be replaced by power traces.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power system comprising:
a daughter board comprising:
a plurality of voltage output ports for outputting a same voltage; and
a plurality of voltage input ports, each voltage input port coupled to a corresponding voltage output port to form isolated power paths;
a mother board comprising a voltage output port for providing electric power to the voltage input ports of the daughter board; and
a plurality of power lines, each power line coupled between a corresponding voltage input port of the daughter board and the voltage output port of the motherboard.

2. The power system of claim 1, wherein each voltage output port of the daughter board is a universal serial bus (USB) port.

3. The power system of claim 1, wherein the daughter board further comprises a plurality of power planes, each power plane coupled between the corresponding voltage input port of the daughter board and the corresponding voltage output port of the daughter board.

4. The power system of claim 1, wherein the daughter board further comprises a plurality of power traces, each power trace coupled between the corresponding voltage input port of the daughter board and the corresponding voltage output port of the daughter board.

5. The power system of claim 1, wherein the motherboard further comprises a regulator capacitor coupled to the voltage output port of the motherboard.

6. The power system of claim 1, wherein the daughter board further comprises a plurality of regulator capacitors, each regulator capacitor coupled to the corresponding voltage output port of the daughter board.

7. An electronic device comprising:
a daughter board comprising:
a plurality of voltage output ports for outputting a same voltage; and
a plurality of voltage input ports, each voltage input port coupled to a corresponding voltage output port to form isolated power paths;
a motherboard comprising:
a central processing unit (CPU) for controlling the operation of the electronic device;
a north bridge circuit coupled to the CPU for controlling devices with high transmission rate;
a south bridge circuit coupled to the north bridge circuit and the daughter board for controlling devices with low transmission rate; and
a voltage output port for providing electric power to the voltage input ports of the daughter board; and
a plurality of power lines, each power line coupled between a corresponding voltage input port of the daughter board and the voltage output port of the motherboard.

8. The electronic device of claim 7, wherein each voltage output port of the daughter board is a USB port.

9. The electronic device of claim 7, wherein the daughter board further comprises a plurality of power planes, each power plane coupled between the corresponding voltage input port of the daughter board and the corresponding voltage output port of the daughter board.

10. The electronic device of claim 7, wherein the daughter board further comprises a plurality of power traces, each power trace coupled between the corresponding voltage input port of the daughter board and the corresponding voltage output port of the daughter board.

11. The electronic device of claim 7, wherein the motherboard further comprises a regulator capacitor coupled to the voltage output port of the motherboard.

12. The electronic device of claim 7, wherein the daughter board further comprises a plurality of regulator capacitors, each regulator capacitor coupled to the corresponding voltage output port of the daughter board.

13. The electronic device of claim 7 being a notebook computer or a personal computer.

14. The electronic device of claim 7, wherein the north bridge circuit and the south bridge circuit are integrated in a single chip.
